(19) United States
(12) Patent Application Publication
(10) Pub. No.: US 2009/0061112 A1
(43) Pub. Date: Mar. 5, 2009

(54) Laser circuit etching by subtractive deposition

(75) Inventor: Josef Kirmeier, Los Gatos, CA (US)

Correspondence Address: FOUNTAINHEAD LAW GROUP, PC, 900 LAFAYETTE STREET, SUITE 509, SANTA CLARA, CA, 95050, US

(73) Assignee: Mu-Gahat Enterprises, LLC, Sunnyvale, CA (US)

(21) Appl. No.: 11/895,766

(22) Filed: Aug. 27, 2007

(51) Int. Cl. H05B 7/00; B05B 5/00

(52) U.S. Cl. 427/596; 118/639

(57) ABSTRACT

In one embodiment the present invention includes a direct-write laser lithography system. The system includes a reel-to-reel feed system that presents the clear film-side of a single-sided metal-clad tape to a laser for direct patterning of the metal. The laser beam is swept laterally across the tape by a moving mirror, and is intense enough to ablate the metal but not so strong as to destroy the tape substrate. The ablated metal becomes deposited to form circuit structures on a target structure.

### CROSS REFERENCE TO RELATED APPLICATIONS

Not applicable.

### BACKGROUND

The present invention relates to flexible circuits, and in particular to methods, systems, and devices for manufacturing flexible circuits in high volumes and at low costs.

Unless otherwise indicated herein, the approaches described in this section are not prior art to the claims in this application and are not admitted to be prior art by inclusion in this section.

Radio frequency identification (RFID) device technology is proliferating everywhere and into everything. Right now, a worldwide effort is stepping into high gear to replace the familiar universal product code (UPC) barcodes on products with RFID tags. The ink and labels used to print UPC barcodes is very inexpensive, and the costs of RFID chips and printed circuit antennas are under a lot of pressure to match them. Large, expensive items, of course, are not price sensitive to the cost of a typical RFID tag. But mass produced commodity items need tags that cost only a few cents.

The majority of printed circuit boards (PCBs) are made by depositing a layer of copper cladding over the entire substrate, then subtracting away the unwanted copper by chemical etching, leaving only the desired copper traces. Some PCBs are made by adding traces to a bare substrate by electroplating.

Three common subtractive methods are used to make PCBs. Etch-resistant inks can be screened on the cladding to protect the copper foils that are to remain after etching. Photoengraving uses a photomask to protect the copper foils, and chemical etching removes the unwanted copper from the substrate. Laser-printed transparencies are typically employed for phototools, and direct laser imaging techniques are being used to replace phototools for high-resolution requirements. PCB milling uses a 2-3 axis mechanical milling system to mill away copper foil from the substrate. A PCB milling machine operates like a plotter, receiving commands from files generated in PCB design software and stored in HPGE or Gerber file format.

Additive processes, such as the semi-additive process, starts with an unpatterned board and a thin layer of copper. A reverse mask is then applied. Additional copper is plated onto the board in the unmasked areas. Tin-lead and other surface platings are then applied. The mask is stripped away, and a brief etching step removes the now-exposed thin original copper laminate from the board, isolating the individual traces.

The additive process is commonly used for multi-layer boards because it favors making plating-through holes (vias) in the circuit board.

Circuit etching methods that use chemicals, coatings, and acids are slow, expensive, and not environmentally friendly. Mechanical etching has been growing rapidly in recent years. Mechanical milling involves the use of a precise numerically controlled multi-axis machine tool and a special milling cutter to remove a narrow strip of copper from the boundary of each pad and trace.

Conventional laser etching of circuit traces is from the side with the metal to be etched. The metal, smoke, and debris goes flying directly in the path of the laser beam trying to do its work. The laser and its optics need frequent cleaning in order to maintain etching efficiency. But lasers can be a very fast, environmentally safe way to mass produce printed circuits, e.g., RFIDs on flexible printed circuits (FPC) using DuPont's KAPTON polyimide film.

Thus, there is a need for improved systems and methods for electronic circuit formation. The present invention solves these and other problems by providing systems and methods for using a laser to ablate metal for deposition of circuit structures onto another medium.

### SUMMARY

Embodiments of the present invention improve systems and methods related to the formation of electronic circuits and related electronic components.

A direct-write laser lithography embodiment of the present invention comprises a reel-to-reel or sheet feed system that presents the reverse side of a single-sided metal-coated media to a laser for ablation of the metal. The laser beam is swept laterally across the media by a moving mirror, and is intense enough to ablate the metal but not so strong as to destroy the media substrate. The ablated metal adheres to a target medium to form circuit structures on the target medium.

According to another embodiment, a laser movement system moves the laser in relation to the metal-coated media in order to direct the laser beam without mirrors.

One feature of certain embodiments of the present invention is a system that can produce RFID circuits on flexible printed circuits at a low cost per unit.

Another feature of certain embodiments of the present invention is a manufacturing method for flexible printed circuits that allows for continuous production.

The following detailed description and accompanying drawings provide a better understanding of the nature and advantages of the present invention.

### BRIEF DESCRIPTION OF THE DRAWINGS

FIG. 1 is a block diagram of a direct-write laser lithography system according to an embodiment of the present invention that uses a laser to ablate metal from film wound reel-to-reel or sheets fed from a sheet feeding system.

FIG. 2 is a block diagram of a direct-write laser lithography system according to another embodiment of the present invention that does not use mirrors for directing the laser.

FIG. 3 is a plan view diagram of a RFID device constructed with a flex circuit antenna etched by the system of FIG. 1 or FIG. 2.

FIG. 4 is a flowchart of a method of laser circuit deposition according to an embodiment of the present invention.

FIG. 5 is a block diagram of a control system for controlling laser ablation according to an embodiment of the present invention.

### DETAILED DESCRIPTION

Described herein are techniques for reverse side film laser circuit etching. In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include obvious modifications and equivalents of the features and concepts described herein.

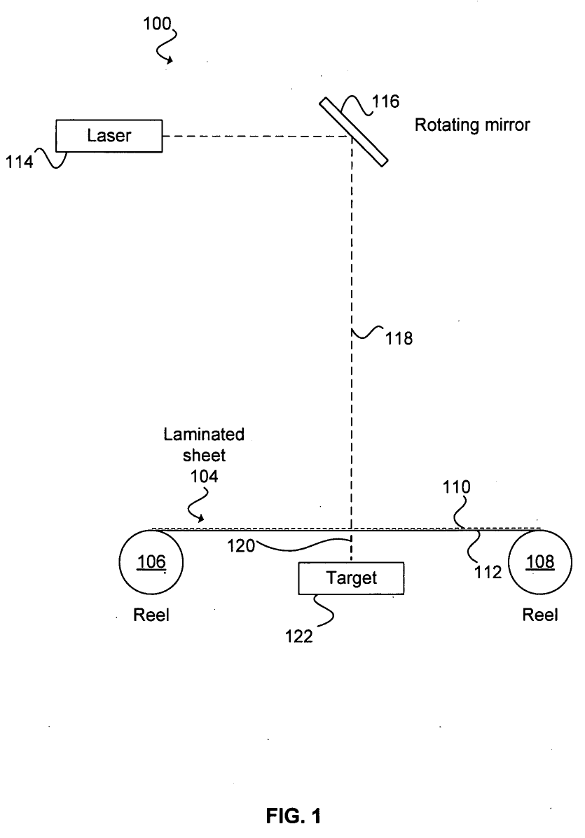

FIG. 1 represents a direct-write laser lithography system embodiment of the present invention, and is referred to herein by the general reference numeral 100. System 100 is used to manufacture flexible printed circuits (FPC), and comprises a metal-on-film substrate tape 104 wound on a supply reel 106 and a take-up reel 108. The tape 104 has a transparent film substrate 110 and a thin-film metal cladding 112. The transparent film substrate 110 may comprise polyimide, PEN, polyester, polycarbonate, etc. The thin-film metal cladding 112 may include copper (Cu), aluminum (Al), platinum (Pt), etc.

A laser 114 is used to ablate off the metal from the backside of tape 104 as it translates from supply reel 106 to take-up reel 108. A mirror 116 moves a laser beam 118 to various lateral points across the tape 104. Once laser beam 118 is positioned properly, a pulse of energy is generated enough to ablate metal 120 away from the tape 104. The ablated metal 120 then adheres to a target structure 122. The laser 114 is controlled to ablate such that the ablated metal 120 forms circuit structures on the target structure 122.

It is theorized that the laser causes the metal to ablate, partially melt, partially vaporize, or partially become plasma. The partially molten or partially vaporized ablated metal 120 then projects toward the target surface 122. Upon contact with the target surface 122, the ablated metal 120 sticks to the target surface in a pattern that generally corresponds to the path followed by the laser 114 as it ablated the metal. In such a manner, ablation by the laser causes the ablated metal to deposit itself in circuit patterns on the target surface 122.

The target structure 122 is generally a flexible material, such that traditional circuit deposition techniques (chemical etching, chemical deposition, etc.) are unworkable or inefficient. Materials envisioned for the target structure 122 include various non-metallic surfaces such as textile, leather, wood, glass, polyvinyl chloride (PVC), organic fibers, etc. However, note that even though the motivation behind certain embodiments of the present invention is to deposit circuit structures onto flexible materials, the techniques of the various embodiments of the present invention also allow the deposition onto more traditional materials such as printed circuit boards, metal, etc.

The above-described process is referred to generally as “subtractive ablative deposition”. The process is “subtractive” in that the ablation subtracts the metal from the coated sheet 104, “ablative” in that the laser ablates the metal from the coated sheet, and involves “deposition” in that the ablated metal becomes deposited on the target structure 122.

Observe in the embodiment shown in FIG. 1 that the ablated metal 120 does not fly or plume into the path of laser beam 118 because the ablation is on the opposite side to the laser. The result is less laser energy is needed to get the job done.

The materials used for the transparent film substrate and the wavelength of laser beam 118 are chosen such that the energy absorbed by the substrate will be minimal and be able to pass the laser energy through to concentrate on ablating the metal 120. This could be assisted by placing an energy absorbing material between the transparent film substrate 110 and a thin-film metal cladding 112. The choice of type and power level of laser 114 will be empirically derived, but initial indications are that a 15 W diode pumped YAG laser will produce the desired results.

According to other embodiments, the tape 104 is radiused so the substrate 110 is under compression and the metal cladding 112 is under tension where they encounter the laser beam 118. Such mechanical stresses and the force of gravity may assist with ablation and not require all the separation energy come from the laser and its heating effects. According to further embodiments, heating, or pre-heating tape 104 may also be used to assist to get the materials up to the points where the metal will ablate more readily and with less violence. According to other embodiments, the tape 104 may be cooled prior to ablation, for example, using liquid nitrogen. Cooling may make a metal such as copper more brittle so that it ablates more easily. The choice of heating, cooling or neither may depend upon the specific material.

The tape 104 may also be referred to as a coated tape. In general, the term “coated” includes both “laminated”, which refers to an adhesive material between the substrate 110 and the metal cladding 112, as well as “sputtered”, which refers to a chromium material between the substrate 110 and the metal cladding 112. These materials help the substrate 110 and the metal cladding 112 to adhere together.

Although a reel-to-reel tape system is shown in the embodiment of FIG. 1, note that other embodiments may instead use a sheet feeder system, or other structure for presenting the tape 104 for ablation. The choice of reel-to-reel tape system, sheet feeder system, or other structure will depend upon various design factors, including the form factor of the coated tape 104.

The mirror 116 may be implemented in various ways. According to one embodiment, the mirror 116 is a swinging mirror that may be tilted on one or more axes, for example, the x-axis or the y-axis. The mirror 116 may be part of a galvo head device. According to another embodiment, the mirror 116 may be a rotating mirror, for example, a many-sided prism type structure that is rotated to direct the laser beam.

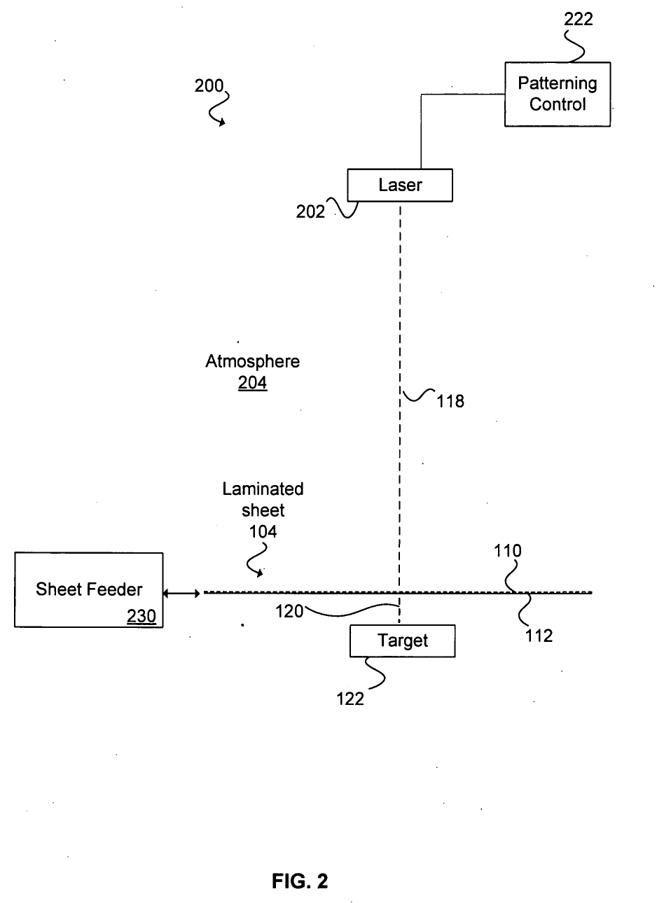

FIG. 2 represents a reverse-side laser ablatement system embodiment of the present invention, which is referred to herein by the general reference numeral 200. System 200 comprises a laser 202, such as a YAG laser that can operate a relatively high power levels, for example, 15 W. It operates in an atmosphere 204 selected with a view toward improving laser operation and reducing the cost of operating the whole of system 204. For example, some applications will be able to do best with an atmosphere 204 of either normal air, reduced pressure, vacuum, or dry, or inert atmospheres like nitrogen or argon. A beam 118 of laser light travels through atmosphere 204 and enters the “back side” of a coated tape 104 comprising a dielectric substrate 110 and a metal cladding 112. An optional intermediate layer may be used between the dielectric substrate 110 and the metal cladding 112. If used, the intermediate layer may comprise UV absorption materials, in the case of a UV laser 202, or other wavelength selective energy absorbing materials coordinated with the selection of laser 202. A sheet feeder system 230 moves the coated sheet 104.

It is a feature of the embodiment shown in FIG. 2 that the material that comprises dielectric substrate 110 be substantially transparent to the laser light beam 118 so that a transitioning beam will be able to deposit a maximum of energy into the metal ablatement area (and to an intermediate heating area if the optional intermediate layer is present). It is desirable that the material of dielectric substrate 110 survive the exposure to laser beam 118 with substantially no damage or heating. It can do that if such material is effective at transmitting the light wavelengths used by laser 202. So the choice of laser can affect the choice of materials for dielectric substrate 110, and vice versa.

If the intermediate layer is present, such intermediate heating area is used to overpressure the ablatement area and stress it to assist in ablating metal 120. If the intermediate layer is not used, then the transitioning beam reaches metal ablatement area directly and melts and vaporizes metal to produce ablating metal 120 according to patterns written by a patterning control block 222.

In general, metal cladding 112 will comprise material conductive to electricity, and dielectric substrate 110 will comprise electrically insulative materials so that patterning control 222 can produce rigid or flexible printed circuits. Typical metals are copper, aluminum, gold, silver, platinum, etc. Typical insulators are polyimide, polycarbonate, silicon dioxide, alumina, glass, diamond, etc., in tapes, boards, films, and dice.

Laser 202, and in particular beam 118, is positioned in coordination with patterning control 222 by means such as pen-plotter mechanisms, x-y stages, micro-mirrors, a galvo head device, etc. according to design tradeoffs in various embodiments. The patterning control 222 in combination with the sheet feeder system 230 work together so that the laser beam 118 ablates the metal from the coated sheet 104 at the desired location. Additional lasers can be included to improve job throughput, or they can be specialized to do wide area or fine feature ablations. Such lasers can use different wavelengths and laser types to assist in such specialization and job sharing. According to another embodiment, to improve throughput, a beam splitter may split a beam from a single laser into multiple beams that are directed by multiple galvo head devices.

The use of a pen-plotter type positioning mechanism for laser 202 permits the propagation distance that beam 118 has to travel through atmosphere 204 to be reduced as compared to certain embodiments that interpose a mirror between the laser and the substrate 110. Such then would permit atmosphere 204 to be ordinary air, whereas a longer travel distance could necessitate the use of vacuum in certain embodiments.

The coated sheet 104 may be implemented in various form factors, and the components of the system 200 may be varied in accordance with the form factor of the coated sheet 104. Conversely, the form factor of the coated sheet 104 may be varied in accordance with the components of the system 200. For example, a reel-to-reel tape system (similar to that shown in FIG. 1) may be implemented in the system 200, in which case the coated sheet 104 may be a coated tape. As another example, the metal layer 112 may have a thickness such that coated sheet 104 may be in sheet form, in which case a sheet feeder may be implemented in the system 200.

Various materials for substrate 110 can be used, the best depending on several variables. A typical substrate tape is 460 mm wide. Table I summarizes the properties of several popular materials. (As reported by LPKF Laser & Electronics AG.)

TABLE I

| | KAPTON | APICAL | UPILEX | KALADEX | MYLAR | MAKROFOL |
|---|---|---|---|---|---|---|
| Tg (° C.) | 385 | >500 | >500 | 122 | 80 | 153 |
| CTE | 15 | 12 | 8 | 20 | 20 | 70 |
| (ppm/° C.) | | | | | | |
| tensile | 24 | 15-24 | 35 | 32 | 28-32 | 20-25 |
| strength | | | | | | |
| Kpsi | | | | | | |
| Water | 2.9 | 2.2 | 1.2 | <1 | <1 | 0.35 |
| absorp. | | | | | | |
| (%/wt.) | | | | | | |
| dielectric | ? | 9.4 | 6.8 | 3.4 | 3.5 | 2.8 |
| strength | | | | | | |

KAPTON, APICAL, and UPILEX are brand names of various forms of polyimide, KALADEX is a polyethylene naphthalate (PEN), MYLAR is a polyester, and MAKROFOL and LEXAN are polycarbonates.

The choice of metal for cladding 112 depends on several tradeoffs. In general, the thinner the metal, the easier is the laser ablation. Thinner materials will have higher sheet resistances, as measured in Ohms per square. A balance between these is to be made in each embodiment. Copper is a good choice for circuit wiring, but the copper material absorbs and dissipates heat very efficiently, and that counters the spot heating effects the laser is trying to obtain for ablation. Aluminum is better in this regard, but gold and platinum may have to be used if the application is in a corrosive environment. The metals' reflectivity, absorptivity, and thermal conductivity are key parameters in the choice of metal to use. LPKF Laser & Electronics AG reported on three of these metals, as in Table II.

TABLE II

| | reflectivity | thermal conductivity | absorptivity |
|---|---|---|---|
| metal | 248 nm | (W/(cm² ° K) | 248 nm |
| copper | 0.366 | 3.98 | 0.62 |
| gold | 0.319 | 3.15 | 0.66 |
| aluminum | 0.924 | 2.37 | |

Early proof-of-concept tests were made with different thicknesses of metal on a polyethylene terephthalate (PET) substrate, and at different reel-to-reel tape speeds, e.g., 0.2 μm Cu at 2.5 m/s, 0.5 μm Cu at 2.5 m/s, 0.2 μm Al at 3.0 m/s, and 0.5 μm Al at 3.0 m/s. The laser was a 15 W diode pumped YAG laser.

In addition, the choice of metal will also depend upon the particular target material 122 selected. For example, a flexible material with a fine weave such as TYVEK brand material could involve a relatively thin layer of metal 112 on the sheet 104. It is theorized that the smaller weave allows less metal to be deposited yet still form a working circuit structure. As another example, a flexible material with a coarse weave such as cotton fibers could involve a relatively thick layer of metal 112 on the sheet 104. It is theorized that the larger weave has more space between the layers of the weave, requiring more metal to be deposited in order to form a working circuit structure.

Furthermore, the properties of the metal (such as the thickness, reflectivity, conductivity and absorptivity) will influence the attributes of the laser (such as the power level and wavelength).

Many kinds of lasing mediums are used for lasers, and the mediums determine the wavelength of the coherent light produced. The right one to use here depends on the films, metals, and processing speeds decided. Excimer lasers operate in the ultraviolet (UV), below 425 nm. The Argon:Fluorine (Ar:F) laser operates at 193 nm, and Krypton:Fluoride (Kr:F) at 248 nm. The nitrogen UV laser emits light at 337 nm. The Argon laser is a continuous wave (CW) gas laser that emits a blue-green light at 488 and 514 nm. The potassium-titanyl-phosphate (KTP) crystal laser operates in green, around 520 nm. Pulsed dye lasers are yellow and about 577-585 nm. The ruby laser is red and about 694 nm. The synthetic chrysoberyl “alexandrite” laser operates in the deep red at about 755 nm. The diode laser operates in the near infrared at about 800-900 nm. The right laser to use in embodiments of the present invention will probably be the hazardous Class-IV types, e.g., greater than 500 mW continuous, or 10 J/cm² pulsed.

YAG lasers are infrared types that use yttrium-aluminum-garnet crystal rods as the lasing medium. Rare earth dopings, such as neodymium (Nd), erbium (Er) or holmium (Ho), are responsible for the different properties of each laser. The Nd:YAG laser operates at about 1064 nm, the Ho:YAG laser operates at about 2070 nm, and the “erbium” Er:YAG laser operates at just about 2940 nm. YAG lasers may be operated in continuous, pulsed, or Q-Switched modes. The carbon-dioxide (CO₂) laser has the longest wavelength at 10600 mm.

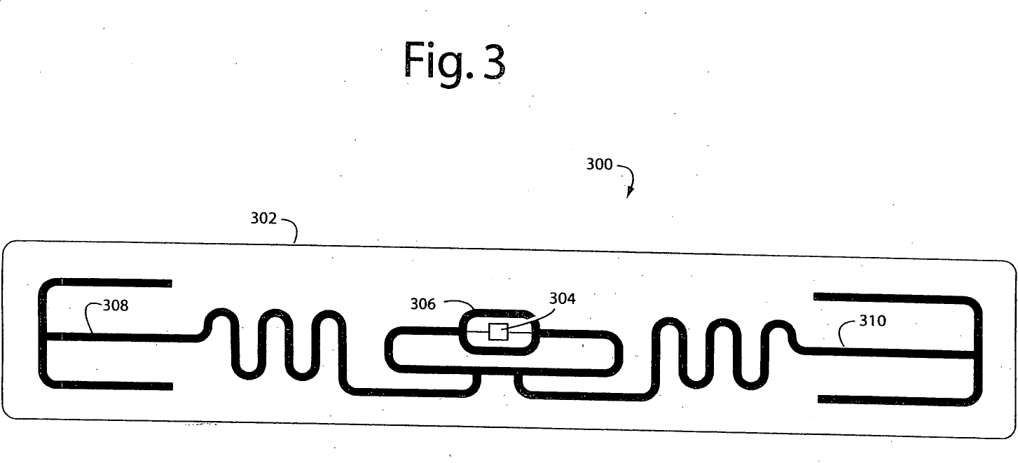

FIG. 3 represents an RFID device 300 with an antenna on a substrate manufactured with system 100 or system 200. The RFID device 300 comprises a film substrate 302 on which has been laser-patterned a folded dipole antenna. A RFID chip 304 is attached to a bond area 306, and these are connected to left and right antenna elements 308 and 310. More specifically, the film substrate 302 was used as the target structure 122. The dimensions of the RFID device 300 may vary as desired, for example, between 1 and 4 inches in length.

The RFID device 300 is one example of an electrical circuit that may be formed according to embodiments of the present invention. Embodiments of the present invention may also be used to form other electrical circuits and electronic devices. As another example, embodiments of the present invention may be used to form thermal circuits such as flexible heaters.

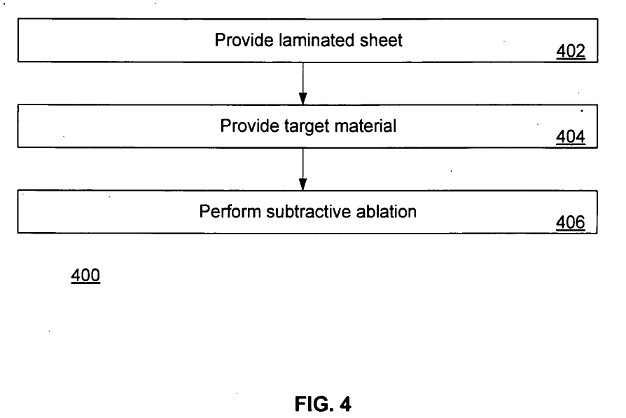

FIG. 4 is a flowchart of a method 400 of laser circuit etching according to an embodiment of the present invention. The method 400 may be implemented by various embodiments of the present invention, such as the embodiment shown in FIG. 1, the embodiment shown in FIG. 2, etc., and variations thereof.

In step 402, a coated sheet is provided. As discussed above, the coated sheet comprises a dielectric substrate layer and a metal foil layer. The coated sheet may be in various form factors, such as in tape form or in sheet form. The specific form factor of the coated sheet may depend upon the specific embodiment of the laser etching device. The form factor of the coated sheet may also depend upon the properties of the metal layer. For example, a tape form factor may be suitable for a thinner metal layer, and a sheet form factor may be suitable for a thicker metal layer. Finally, as discussed above, the properties of the metal may depend upon the specific target material 122 selected.

In step 404, the target material is provided. As discussed above, the target material may be a flexible material that may be unsuitable for the formation of circuit structures according to traditional circuit formation techniques.

In step 406, subtractive ablation is performed. As discussed above, the laser ablates metal in a defined pattern, and the ablated metal conforms to the pattern as it becomes deposited to the target material. In this manner, circuit structures are formed on the target material.

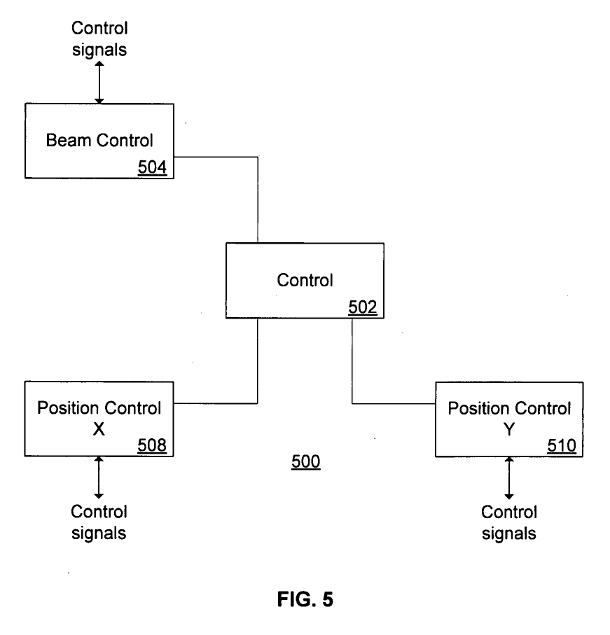

FIG. 5 is a block diagram of a control system 500 for controlling laser ablation according to an embodiment of the present invention. The control system 500 includes a master control block 502, beam control block 504, position control X block 508, and position control Y block 510. The control system 500 generally controls the operation of the laser etching system according to the various embodiments of the present invention. The control system 500 may be implemented in hardware, software, or a combination of hardware and software.

The master control block 502 generally coordinates the other components of the control system 500. The master control block may store a program or other set of instructions for performing a specific set of ablations, and may then instruct the other components of the control system in accordance with the program or other instructions.

The beam control block 504 controls the operation of a laser in an embodiment of the present invention (for example, laser 114 in FIG. 1) via control signals. The control signals may indicate the activation of the laser, the power of the laser, or other controllable attributes of the laser in accordance with the specifics of the ablation desired.

The position control X block 508 controls, via control signals, the relative position between the laser and the coated sheet in an embodiment of the present invention. For example, in the laser etching system 100 of FIG. 1, the position control X block 508 controls the movement of the coated film 104 from one reel to another. The movement may be from the reel 108 to the reel 106, or vice versa. As another example, in the laser etching system 200 of FIG. 2, the position control X block instructs the patterning control 222, for example, to move the laser 202 along an x-axis, along a y-axis, or in a combination of x-axis and y-axis movement.

The position control Y block 510 controls, via control signals, other aspects of the relative position between the laser and the coated sheet not otherwise controlled by the position control X block 508 in an embodiment of the present invention. For example, in the laser etching system 100 of FIG. 1, the position control Y block 510 controls the mirror 116. In such manner, the movement of the coated film 104 and the mirror 116 can be coordinated so that the laser beam 118 ablates at the desired location on the coated film 104.

According to another embodiment, the position control Y block 510 controls, via control signals, the relative position between the metal sheet and the target material.

As discussed above, the systems and methods according to various embodiments of the present invention are suitable for flexible circuit manufacturing techniques. Flexible circuits may be used in many different applications, including RFID antennas, RFID tag circuitry, membrane switches, flexible heaters and printed circuits, data compact disks, and data video disks.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims. The terms and expressions that have been employed here are used to describe the various embodiments and examples. These terms and expressions are not to be construed as excluding equivalents of the features shown and described, or portions thereof, it being recognized that various modifications are possible within the scope of the appended claims.

What is claimed is:

1. A method of depositing metal structures, said method comprising the steps of:
providing a coated sheet, said coated sheet having a first side that comprises a dielectric substrate and a second side that comprises a metal;
providing a target structure; and
controlling a laser to generate a laser beam toward said first side of said coated sheet such that said laser beam passes through said first side, ablates portions of said second side, and deposits circuit structures on said target structure.

2. The method of claim 1, further comprising:
configuring said coated sheet into a tape;
mounting said tape into a reel-to-reel transport system; and
controlling said reel-to-reel transport system to move said tape relative to said laser.

3. The method of claim 1, further comprising:
moving a mirror in a path of said laser beam to provide for transverse movement of said laser beam across said coated sheet.

4. The method of claim 1, further comprising:
heating said coated sheet, in order to reduce an amount of laser power needed to ablate said metal.

5. The method of claim 1, further comprising:
mechanically stressing said coated sheet, in order to reduce an amount of laser power needed to ablate said metal.

6. The method of claim 1, further comprising:
cooling said coated sheet, in order to reduce an amount of laser power needed to ablate said metal.

7. The method of claim 1, wherein said coated sheet further comprises a laser energy absorbing material between said dielectric substrate and said metal, wherein said laser energy absorbing material assists in ablation of said metal from said second side.

8. An apparatus including a flexible circuit etching system, said flexible circuit etching system comprising:
a reel-to-reel tape system that linearly presents a coated tape, wherein said coated tape has a first side that comprises a dielectric substrate and a second side that comprises a metal;
a laser that generates a laser beam having a power sufficient to ablate said metal from said second side of said coated tape; and
a mirror that controllably moves to direct said laser beam toward said first side of said coated tape such that said laser beam passes through said first side, ablates portions of said second side, and deposits circuit structures on a target structure.

9. The apparatus of claim 8, further comprising:
a control system, coupled to said reel-to-reel tape system, to said laser, and to said mirror, that controls said reel-to-reel tape system, said laser, and said mirror,
wherein said control system controls said reel-to-reel tape system and said mirror to coordinate appropriate placement of said coated tape in accordance with control of said laser.

10. An apparatus including a laser ablation machine for patterning metal onto a target, said laser ablation machine comprising:
a laser; and
a patterning control system that positions said laser in relation to a coated sheet, wherein said coated sheet has a first side that comprises a dielectric substrate and a second side that comprises a metal,
wherein said laser generates a laser beam having a power sufficient to ablate said metal from said second side of said coated sheet, and wherein said laser beam passes through said first side, ablates portions of said second side, and deposits circuit structures on a target structure.

11. The apparatus of claim 10, further comprising:
a control system, coupled to said laser and to said patterning control system, that controls said laser and said patterning control system,
wherein said control system controls said patterning control system to coordinate appropriate placement of said laser in relation to said coated sheet in accordance with control of said laser.

12. An apparatus including an electrical circuit, said electrical circuit produced by a method comprising the steps of:
providing a coated sheet, said coated sheet having a first side that comprises a dielectric substrate and a second side that comprises a metal;
providing a target structure; and
controlling a laser to generate a laser beam toward said first side of said coated sheet such that said laser beam passes through said first side, ablates portions of said second side, and deposits said portions having been ablated to form said electrical circuit on said target structure.

13. The apparatus of claim 12, wherein said electrical circuit comprises an antenna for a radio frequency identification (RFID) tag.

14. The apparatus of claim 12, wherein said electrical circuit comprises a thermal circuit.
